(19) United States
(12) Patent Application Publication
(10) Pub. No.: US 2012/0045949 A1
(43) Pub. Date: Feb. 23, 2012

(54) ELECTRICAL CONTACT

(76) Inventor: Sung-Tien Lin, Wugu Township (TW)

(21) Appl. No.: 12/858,431

(22) Filed: Aug. 17, 2010

(51) Int. Cl. H01R 4/48

(52) U.S. Cl. 439/861

(57) ABSTRACT

The present invention is to provide an electrical contact, including first and second contact arms being spaced apart from each other in a vertical relation and having a contact portion, respectively, a soldering arm connected with the second contact arm, a driven arm connected with the first contact arm, and a support arm disposed between and connecting the first and second contact arms and the soldering and driven arms, wherein the contact portions of the first and second contact arms are disposed in different alignment with each other so as to clamp a flexible circuit board securely.

### BACKGROUND OF THE INVENTION

1. Field of the Invention

The present invention relates to an electrical connector, and particularly to an electrical contact adapted to be mounted in a flexible circuit board to ensure that a flexible circuit board is firmly retained by the contact and to prevent the flexible circuit board from being disengaged.

2. Related Art

A conventional contact mounted in a flexible circuit board connector includes a first arm and a second arm spaced apart from the first arm each having a projection thereon for holding a flexible circuit board, a driven arm and a soldering arm respectively extend from ends of the first and second arms, and a linking arm disposed between the first and second arms and the driven and soldering arms. Due to leverage, the first arm is able to pivot about the linking arm towards the second arm when the driven arm is pressed by a pressure member so as to narrow an insertion opening defined by the first and second arms and to hold a flexible circuit board therein.

Unfortunately, the projections of the first and second arms are located directly opposite to each other in order to hold the flat flexible circuit board between the first and second arms. In other words, the flexible circuit board is held by a holding force applied on surfaces thereof from directly opposite directions in a same vertical plane. As a result, the flexible circuit board is easily to be disengaged from the contact when the flexible circuit board is inappropriately drawn.

### SUMMARY OF THE INVENTION

Accordingly, an object of the present invention is to provide an electrical contact having first and second contact arms being able to efficiently and firmly clamp a flexible circuit board.

To achieve the above-mentioned objects, an electrical contact of the present invention includes first and second contact arms being spaced apart from each other in a vertical relation and having a contact portion, respectively, a soldering arm connected with the second contact arm, a driven arm connected with the first contact arm, and a support arm disposed between and connecting the first and second contact arms and the soldering and driven arms, wherein the contact portions of the first and second contact arms are disposed in different alignment with each other so as to clamp a flexible circuit board securely.

According to the above-mentioned features, when the driven arm is being pressed, the first contact arm is rotated about the support arm in a reverse direction with respect to a direction that the driven arm is driven.

### BRIEF DESCRIPTION OF THE DRAWINGS

FIG. 1 is a front elevational view of an electrical contact of the present invention;

FIG. 2 is a partially schematic sectional view showing the electrical contact of the present invention being mounted in a dielectric housing;

FIG. 3 is a schematic view showing a flexible circuit board is clamped by the electrical contact of the present invention; and

FIGS. 4 and 5 are schematic views showing the electrical contact of the present invention being operated by a pressure member.

### DESCRIPTION OF THE PREFERRED EMBODIMENTS

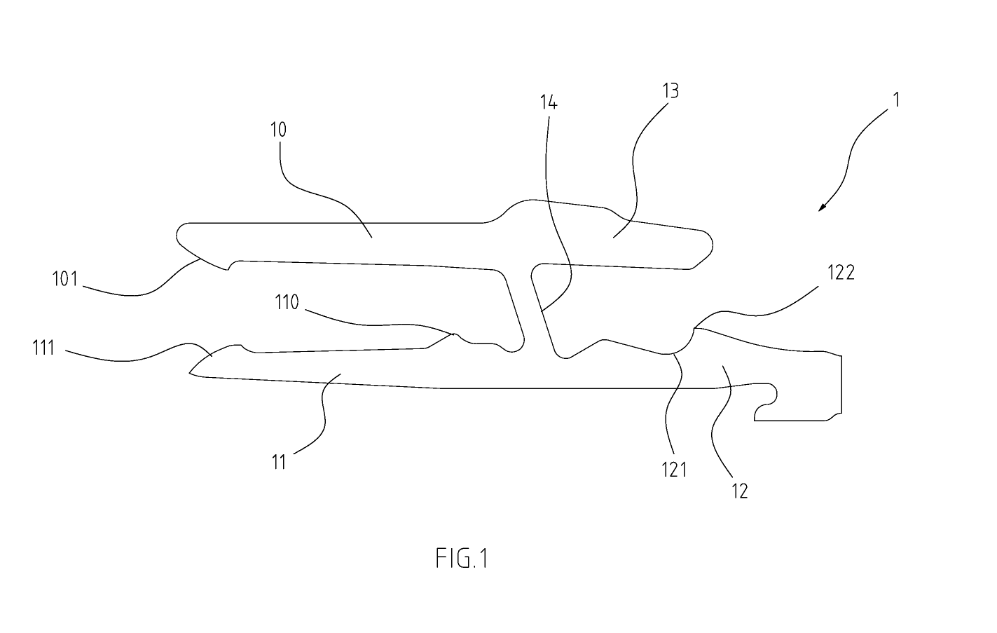

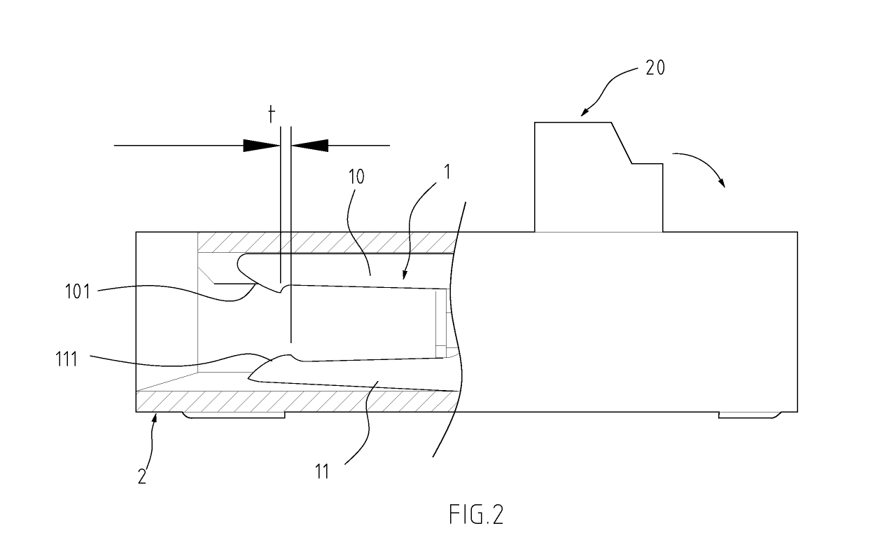

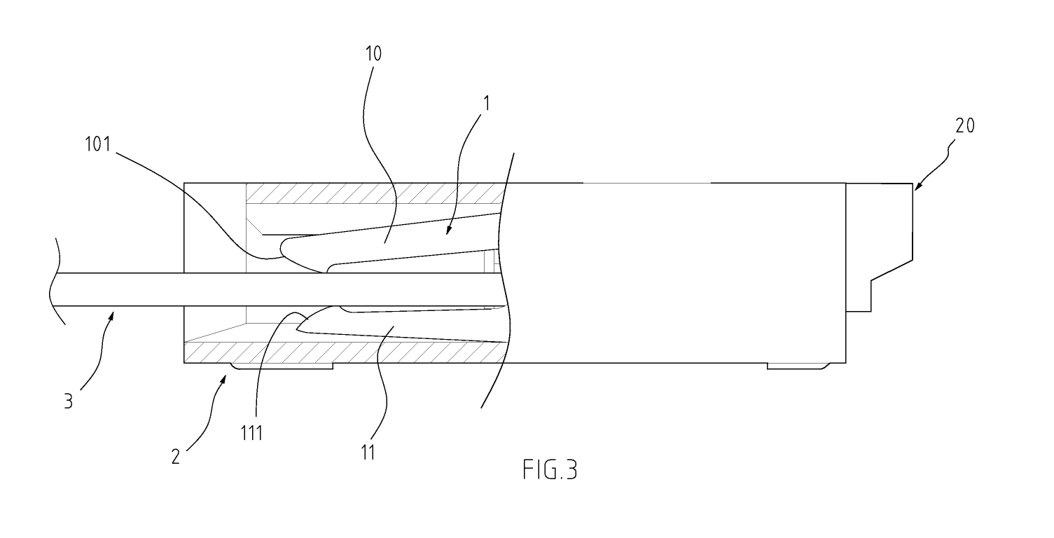

Referring to FIG. 1 in combination with FIGS. 2 and 3, an electrical contact 1 of the present invention is adapted to be mounted in a flexible circuit board connector 2. The electrical contact 1 includes a first contact arm 10, a second contact arm 11, a soldering arm 12, a driven arm 13, and a support arm 14, wherein the first and second contact arms 10, 11 are spaced apart from each other in a vertical relation such that the first contact arm 10 is located above the second contact arm 11, and the first and second contact arms 10, 11 have contact portions 101, 111, respectively. The contact portions 101, 111 project towards each other from sides of the first and second contact arms 10, 11, respectively, and are disposed in different alignment with each other where projecting tops (not labeled) of the contact portions 100, 111 are spaced in a distance t in a horizontal direction and are adapted to electrically contact and clamp a flexible circuit board 3. The second contact arm 11 is formed with a protrusion 110 being adjacent to the support arm 14 and towards the first contact arm 10 for enabling the flexible circuit board 3 to be clamped more securely. The driven arm 13 and the soldering arm 12 are located at right sides of the first and second contact arms 10, 11 with respect to the support arm 14, respectively. The soldering arm 12 is soldered to a printed circuit board (not shown) and is laterally provided with a pivot slot 121 of a reverse J shape towards the driven arm 13. The pivot slot 121 has a shoulder portion 122 and is adapted to pivotally receive a pressure member 20 thereon (referring to FIGS. 2 and 3). The length of the driven arm 13 is shorter than that of the first contact arm 10 and is located above the pivot slot 121. The support arm 14 is slightly inclined between the first and second contact arms 10, 11 and the soldering and driven arms 12, 13. When the driven arm 13 is being pressed by the pressure member 20, the first contact arm 10 is rotated about the support arm 14 in a reverse direction with respect to a direction that the driven arm 13 is pressed, that is, the first contact arm 10 is rotated towards the second contact arm 11.

Particularly, the contact portion 101 of the first contact arm 10 is located in front of the contact portion 111 of the second contact arm 11 as shown in FIG. 1. Consequently, the contact portions 100, 111 are spaced away in the distance t in the horizontal direction (as shown in FIG. 2). The flexible circuit board 3 is therefore clamped tightly between the contact portions 101, 111 when the first contact arm 10 is being rotated. Moreover, the protrusion 110 projects towards the first contact arm 10 at a height higher than a top of the contact portion 111 so that the flexible circuit board 3 is preliminarily positioned and clamped between the first and second contact arms 10, 11.

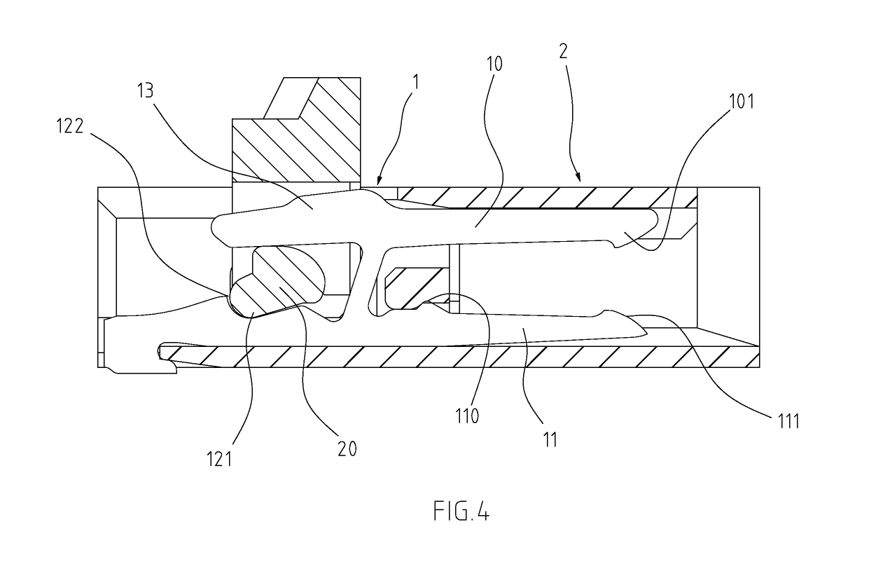

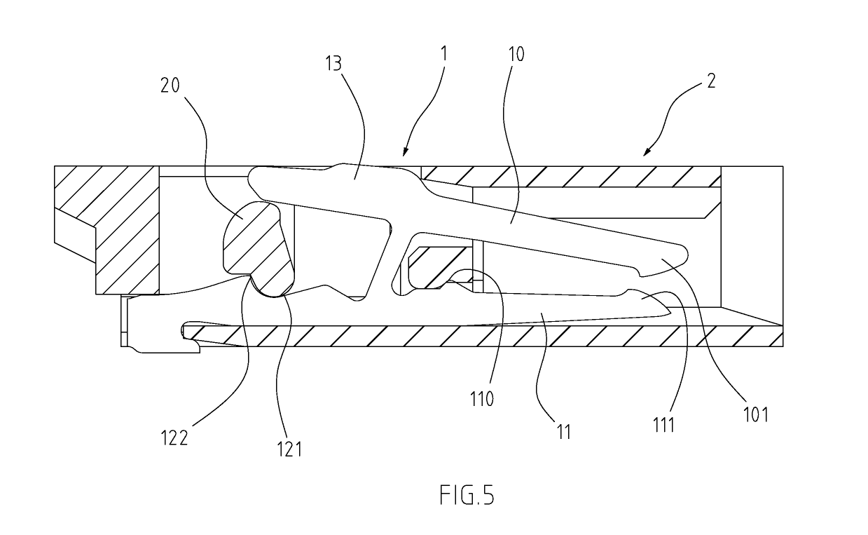

Referring to FIGS. 4 and 5, after the electrical contact 1 is being mounted in the connector 2, the first contact arm 10 and the second contact arm 11 are spaced apart from each other with the support arm 14 connected therebetween in which the flexible circuit board 3 is inserted (as shown in FIG. 3), and the contact portions 101, 111 are disposed in different alignment with each other as described above. When the pressure member 20 pivots on the reverse J-shaped pivoting slot 121 to press against the driven arm 13 upwardly, the first contact arm 10 rotates about the support arm 14 towards the second contact arm 11 and therefore clamps the flexible circuit board 3 tightly together with the second contact arm 11 by the contact portions 101, 111.

It is understood that the invention may be embodied in other forms within the scope of the claims. Thus the present examples and embodiments are to be considered in all respects as illustrative, and not restrictive, of the invention defined by the claims.

What is claimed is:

1. An electrical contact adapted to be mounted in a dielectric housing of a flexible circuit board connector, comprising:
first and second contact arms being spaced apart from each other in a vertical relation and having contact portions, respectively;
a soldering arm connected with the second contact arm and a driven arm connected with the first contact arm; and
a support arm disposed between and connecting the first and second contact arms and the soldering and driven arms;
wherein the contact portions of the first and second contact arms are disposed in different alignment with each other so as to clamp a flexible circuit board securely.

2. The electrical contact of claim 1, wherein when the driven arm is being pressed, the first contact arm is rotated about the support arm in a reverse direction with respect to a direction that the driven arm is pressed.

3. The electrical contact of claim 2, wherein the contact portion of the first contact arm is located in front of the contact portion of the second contact portion.

4. The electrical contact of claim 1, wherein the soldering arm is laterally provided with a pivot slot towards the driven arm.

5. The electrical contact of claim 4, wherein the second contact arm is formed with a protrusion being adjacent to the support arm and towards the first contact arm.

6. The electrical contact of claim 4, wherein the pivot slot is of a reverse J shape and forms a shoulder portion thereon.

7. The electrical contact of claim 4, wherein length of the driven arm is shorter than that of the first contact arm, and the driven arm is located above the pivot slot.

8. The electrical contact of claim 1, wherein the support arm is inclined between the first and second contact arms and the soldering and driven arms.
